(19) United States
(12) Patent Application Publication
(10) Pub. No.: US 2021/0334480 A1
(43) Pub. Date: Oct. 28, 2021

(54) SYSTEMS AND METHODS OF DETECTING SCAN AVOIDANCE EVENTS

(71) Applicant: ZEBRA TECHNOLOGIES CORPORATION, Lincolnshire, IL (US)

(72) Inventors: Abhilash Gururaja, Levittown, NY (US); Christopher J. Fjellstad, Smithtown, NY (US)

(21) Appl. No.: 16/861,008

(22) Filed: Apr. 28, 2020

(51) Int. Cl. G06K 5/04; G07G 3/00; G07G 1/00; G06Q 20/20; G06K 9/00

(52) U.S. Cl. CPC G06K 5/04; G07G 3/003; G07G 1/0081; G06K 2009/00738; G06Q 20/208; G06K 9/00771; G06K 9/00711; G06Q 20/203

(57) ABSTRACT

Methods of detecting scan avoidance events during decode sessions are disclosed herein. An example method includes decoding, during a timeout period at one or more processors of the symbology scanner, a first indicia in a first image captured during the timeout period to determine a first indicia payload; conveying, during the timeout period at the one or more processors, the first indicia payload to a point-of-sale (POS) system for affecting a transaction; detecting, during the timeout period at the one or more processors, a second indicia in the first image or in a subsequent image captured during the timeout period; and in response to determining that the second indicia is the same as the first indicia and is decodable, determining a potential scan avoidance attempt and generating a scan avoidance alarm signal.

### BACKGROUND

In a retail environment, purchasing items typically involves using a barcode reader at a point-of-sale (POS) system to capture images of barcodes attached to each item to be purchased, and decoding the images to identify each item being purchased. In some cases, retail employees scan barcodes on each item a customer wishes to purchase, while in other cases, customers scan the barcodes on items they wish to purchase at self-checkout stations.

### SUMMARY

In an embodiment, a computer-implemented method for detecting a potential scan avoidance during a decode session using a symbology reader includes: decoding, during a timeout period at one or more processors of the symbology scanner, a first indicia in a first image captured during the timeout period to determine a first indicia payload; conveying, during the timeout period at the one or more processors, the first indicia payload to a point-of-sale (POS) system for affecting a transaction; detecting, during the timeout period at the one or more processors, a second indicia in the first image or in a subsequent image captured during the timeout period; and in response to determining that the second indicia is the same as the first indicia and is decodable, determining a potential scan avoidance attempt and generating a scan avoidance alarm signal.

In variations of the above embodiment, the method further includes, in response to determining that the second indicia is different from the first indicia and is decodable, determining a potential scan avoidance attempt has not occurred and not generating a scan avoidance alarm signal.

In variations of the above embodiments, the method further includes: determining a second indicia payload for the second indicia; and conveying the second indicia payload to the POS system.

In variations of the above embodiments, the method further includes: in response to determining that the second indicia is not decodable, not determining a potential scan avoidance attempt and not generating a scan avoidance alarm signal.

In variations of the above embodiments, the second indicia includes the first indicia captured an additional time.

In another embodiment, a system for detecting a scan avoidance event during a decode session comprises: an imaging assembly configured to capture, during a timeout period, a first image of a first indicia, and a second image; a barcode decoder configured to, during the timeout period, decode the first indicia to determine a first indicia payload and convey the first indicia payload to a point-of-sale (POS) system; and a scan avoidance event detector configured to, during the timeout period, in response to determining that a second indicia is the first image and is decodable, determine a potential scan avoidance attempt and generate a scan avoidance alarm signal.

In variations of the above embodiment, the system further comprises: a processor; and a tangible machine-readable storage medium storing machine-readable instructions that, when executed by the processor, cause the processor to implement the scan avoidance event detector.

### BRIEF DESCRIPTION OF THE DRAWINGS

FIG. 1 illustrates a perspective view of an example POS system, in accordance with aspects of this disclosure.

FIG. 2 illustrates a cross-sectional perspective view of an example bi-optic barcode reader including a scan avoidance event detector, in accordance with aspects of this disclosure.

FIG. 3 is a flowchart representative of example methods, logic or machine-readable instructions for implementing the example scan avoidance event detector of FIG. 1, in accordance with aspects of this disclosure.

FIG. 4 is a block diagram of an example logic circuit to implement the example methods, apparatus, logic, and/or operations described herein.

In the accompanying figures, like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention. In general, the same reference numbers will be used throughout the drawing(s) and accompanying written description to refer to the same or like parts.

The apparatus and method components have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein. Skilled artisans will readily recognize from the following discussion that alternate embodiments of the structures and methods illustrated herein may be employed without departing from the principles set forth herein.

### DETAILED DESCRIPTION

As a retail employee or customer scans items for purchase, “scan avoidance,” which may be accidental or intentional, may occur. Scan avoidance represents loss of revenue due to theft, accident, misuse, etc. In some examples, during scan avoidance, items are scanned at a rate that may prevent all items from being detected, identified and/or reported. For example, items may be scanned at an accelerated or rapid rate greater than the rate at which a point-of-sale (POS) system can, or is intended to, capture and decode indicia. Thus, for instance, when a shopper buys multiple (e.g., ten) items of the same kind, all ten items may pass by, pass thru, or be sensed by, etc. a barcode reader, but only seven are paid for. In such instances, three of the ten items may have been decoded, but their payload information may not have been passed to the POS system because they were decoded during the same timeout period as a preceding item and, thus, as intended, designed, etc., were not reported to the POS system. An example timeout period represents a time duration (e.g., five hundred milliseconds during which duplicate indicia are reported to the POS system. Thus, when some scan avoidance events occur, it has been advantageously discovered that when more than one indicia is captured (e.g., imaged) during a same timeout period. The captured indicia may be the same (e.g., purchasing multiple of the same item) or different. Accordingly, in disclosed examples, when more than one indicia (same or different) are detected and decoded during the same timeout period, then it is likely that a scan avoidance event has occurred, and a store manager can be notified. Advantageously, the examples disclosed herein reduce lost revenue, without the use of expensive and/or complex neural networks and/or complex image processing currently in use in some retail stores. Such expensive and/or complex neural networks may prevent their usage in some retail stores.

While for ease of discussion, the following disclosure refers to barcodes, aspects of this disclosure may be used to identify, detect, flag, alert scan avoidance events for any number and/or type(s) of indicia including, barcodes, QR codes, custom codes, etc. Further, while the following disclosure refers to example barcode readers and POS systems, aspects of this disclosure may be used with any number and/or type(s) of symbology readers including bi-optical readers, bi-optic readers, etc. for use with any number and/or type(s) of scanners including, for example, stationary barcode readers, handheld barcode readers, presentation mode barcode readers, etc. Moreover, while example barcode readers are disclosed in conjunction with POS systems, aspects of this disclosure to detect scan avoidance events can be used in conjunction with storage systems, inventory systems, etc. Example indicia include, but are not limited to, symbols that represent multi-digit numbers such as a universal product code (UPC), a European article number (EAN), etc., and may be one-dimensional, two-dimensional and/or three-dimensional.

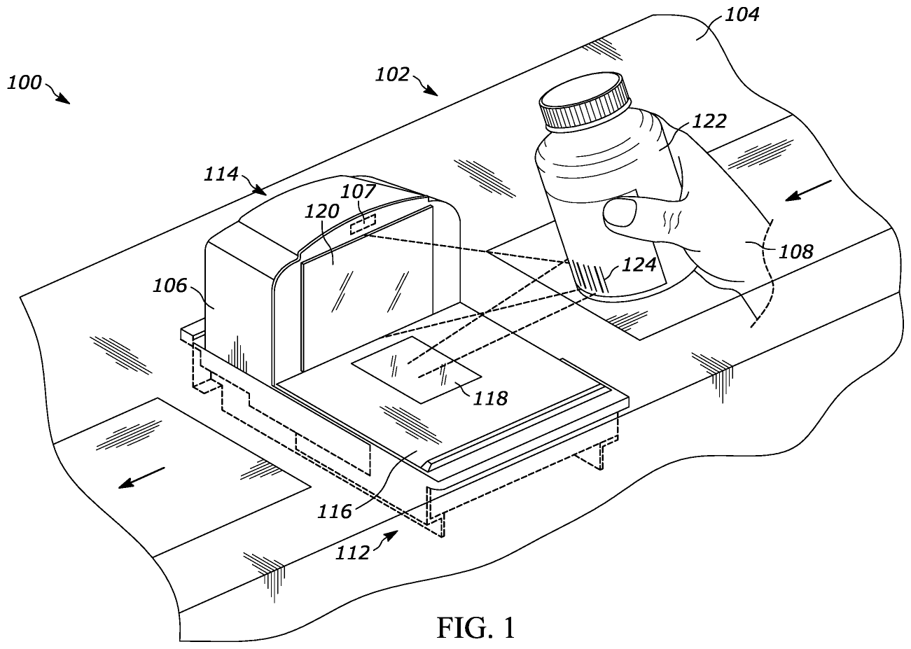

FIG. 1 illustrates a perspective view of an example POS system 100 having a workstation 102 with a counter 104 and a bi-optic barcode reader 106 that may be used to implement the example systems and methods disclosed herein to determine potential scan avoidance events by detecting the scanning of items at, a potentially intentional, accelerated or rapid rate. For example, at a rate greater than which a POS system can, or is intended to, capture, decode and report indicia. Thus, when more than one indicia are captured, or multiple captures of the same indicia occur during a same timeout period, a potential scan avoidance event is determined. The POS system 100 is often managed, operated, etc. by a store employee such as a clerk 108. However, in other cases the POS system 100 may be a part of a so-called self-checkout lane where instead of a clerk, a customer is responsible for checking out his or her own products.

The barcode reader 106 includes a first (e.g., lower) housing 112 and a second (e.g., raised, vertical or tower) housing 114. The lower housing 112 includes a top portion 116 with a first optically transmissive window 118 positioned therein along a generally horizontal plane relative to the overall configuration and placement of the barcode reader 106. Generally speaking, the top portion 116 includes a removable or a non-removable weigh platter (e.g., an electronic scale configured to measure/register the weight of objects placed on the top portion 116). The top portion 116 is positioned substantially parallel with a top surface of the counter 104. As set forth herein, the phrase “substantially parallel” means +/−30° of parallel and/or accounts for manufacturing tolerances. While in FIG. 1, the counter 104 and the top portion 116 are illustrated as being about co-planar, the top portion 116 and the counter 104 may, additionally and/or alternatively, be considered as being about parallel. In some examples, the surface of the counter 104 is raised or lowered relative to the top portion 116, while the top portion 116 remains substantially parallel with the top surface of the counter 104. The raised housing 114 is configured to extend above the top portion 116 and includes a second optically transmissive window 120 positioned in a generally upright plane relative to the top portion 116 and/or the first optically transmissive window 118. Note that references to “upright” include, but are not limited to, vertical. Thus, as an example, something that is upright may deviate from a vertical axis/plane by as much as 30°.

In practice, a product, object, item 122, etc., such as for example a bottle, is moved, swiped, etc. past the barcode reader 106 such that a barcode 124 associated with the item 122 is read (e.g., imaged and decoded) through at least one of the first optically transmissive window 118 and the second optically transmissive window 120. This is particularly done by positioning the item 122 within fields of view (FOV) of digital imaging sensor(s) (e.g., a camera 107) housed inside the barcode reader 106 behind the windows 116 and 118. Additionally, as the item 122 is moved past the barcode reader 106, the cameras obtain image data of the item 122. In some examples, the image data is to verify that the item 122 scanned matches the barcode 124.

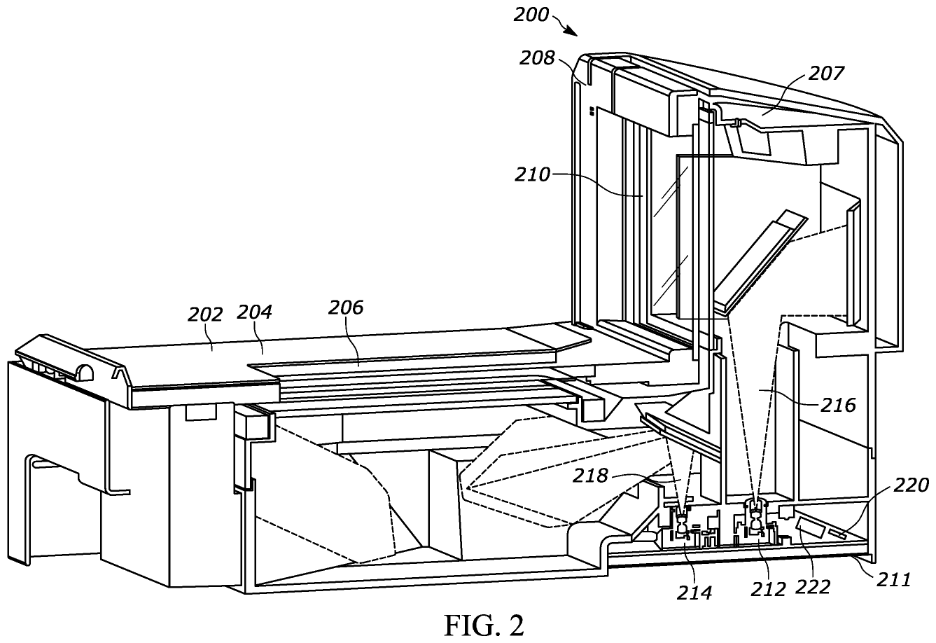

FIG. 2 illustrates a cross-sectional perspective view of an example bi-optic barcode reader 200 that can be used to implement the barcode reader 106 of FIG. 1, in accordance with embodiments of this disclosure. As shown, the barcode reader 200 includes an example first (e.g., lower or platter) housing portion 202 that supports a generally horizontal weigh platter 204 having a first, generally horizontal window 206. The barcode reader 200 is also shown including an example second (e.g., raised, vertical or tower) housing portion 208 that supports a second, generally vertical optically transmissive window 210. As shown, the first window 206 is substantially perpendicular relative to the second window 210. As set forth herein, the phrase “substantially perpendicular” means +/−30° of perpendicular and/or accounts for manufacturing tolerances.

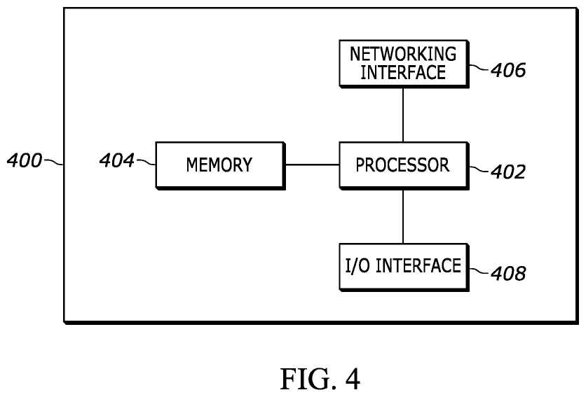

To enable imaging data to be obtained by the barcode reader 200, the barcode reader 200 includes a printed circuit board (PCB) 211 with one or more imaging assemblies 212, 214 (e.g., cameras). Each of the imaging assemblies 212, 214 includes an imaging sensor having a plurality of photosensitive elements that define a substantially flat surface along with other components such as a housing and lens(es) for capturing image data for a FOV. The arrangement and configuration of the components including the imaging sensor, the photosensitive elements, the housing, the lens(es) define a specific FOV for each of the imaging assemblies 212, 214. As shown, the first imaging assembly 212 is configured to capture image data over a first FOV 216 and the second imaging assembly 214 is configured to capture image data over a second FOV 218. The image data captured by the first and second imaging assemblies 212, 214 may include image data representative of an environment in which a barcode or target may appear. In some examples, the logic circuit 400 of FIG. 4 implements the PCB 211. In various examples, the example processes described in reference to PCB 211 and/or, more generally aspects of the PCB 211 may be achieved in hardware, in software, firmware, and/or some combination thereof.

To decode indicia from images of indicia, the PCB 211 includes any number and/or type(s) of barcode decoder 220. To detect potential scan avoidance events, the PCB 211 includes an example scan avoidance event detector 222. The scan avoidance event detector 222 determines a potential scan avoidance event when the scanning of items is at a rate that results in the decoding of multiple indicia during the same timeout period. Because the barcode reader 200 is not intended to report to the POS system 100 multiple barcodes during the same timeout period, the scanning of items at such a rate results in items not being reported and, thus, not charged for and thereby not paid for. Thus, when more than one indicia is decoded during the same timeout period, it is likely that a scan avoidance event has occurred. When a scan avoidance event is likely, the scan avoidance event detector 222 generates a scan avoidance alert signal, alert, notification, report, etc. In some examples, an indication of the generated alert indicating the potential scan avoidance event is presented to a user of the barcode reader 200, e.g., via a user interface of a POS system 100. Additionally and/or alternatively, an indication of the generated alert indicating the potential scan avoidance event may be sent (e.g., as alerts occur, periodically, etc.) to another (e.g., remote) computing device for presentation to an individual distinct from a user of the barcode reader (e.g., a manager, owner, or other stakeholder associated with the retail environment). Further, the alert may be stored, recorded, etc. for subsequent recall. Alerts, notifications, etc. can be sent, transferred, etc. via any number and/or type(s) of communication interfaces, devices, networks, etc.

In some examples, generating the alert or notification indicating the potential scan avoidance event includes capturing an image of a user of the barcode reader 200 via another camera distinct from the barcode reader's camera(s) 212, 214. For example, the additional camera may be positioned and/or angled to capture an image of the face of a user operating the barcode reader 200. In some examples, a facial recognition algorithm may be used to analyze the image of the face of the user to identify the user associated with the potential scan avoidance event. In other examples, the image of the face of the user operating the barcode reader 200 may be sent to a computing device associated with a manager, owner, or other stakeholder associated with the retail environment.

In some examples, the barcode decoder 220 and the scan avoidance event detector 222 are implemented as one or more modules of machine-readable instructions executing on a processor or logic device, such as the processor 402 of the logic circuit 400 of FIG. 4. Additionally and/or alternatively, the barcode decoder 220 and/or the scan avoidance event detector 222 may be implemented by hardware, software, firmware, and/or some combination thereof.

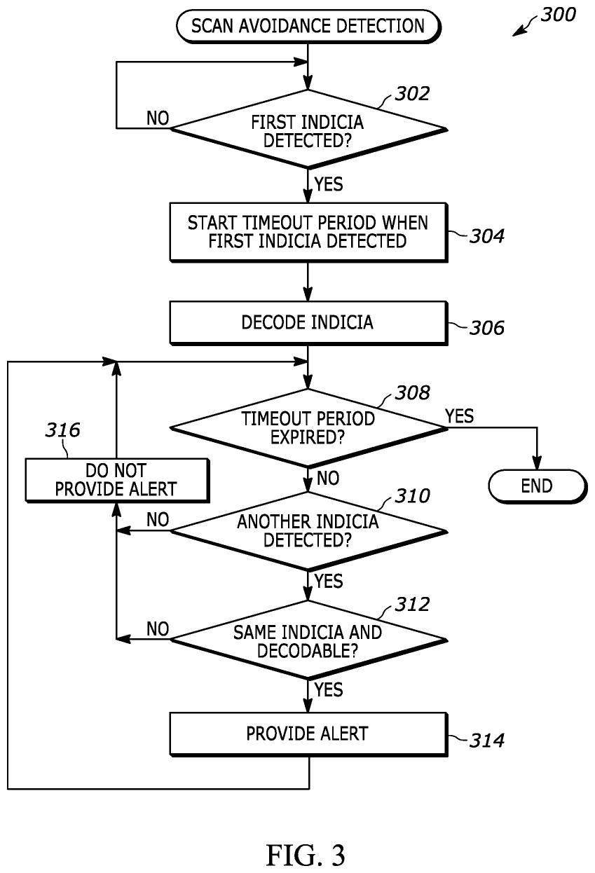

A flowchart 300 representative of example processes, methods, logic, software, computer- or machine-readable instructions for implementing the scan avoidance event detector 222 is shown in FIG. 3. In some examples, the example processes, methods, logic, software, computer- or machine-readable instructions of FIG. 3 are carried out during a decode session of the barcode reader 200. The program of FIG. 3 begins at block 302 when a first (e.g., initial, starting, etc.) indicia 124 is detected (block 302). When the first indicia 124 is detected (block 302), a timeout period is started (block 304). An example timeout period represents a time duration (e.g., five hundred milliseconds during which duplicate indicia are reported to the POS system. The first indicia 124 is decoded (block 306) and reported to a POS system. While the timeout period has not expired (block 308), the scan avoidance event detector 222 determines whether another indicia (e.g., next, second, third, etc.) has been detected (block 310). The scan avoidance event detector 222 determines whether the another indicia (same as the first indicia, or different from the first indicia) is decodable (block 312). If the another indicia is the same as the first indicia and is decodable (block 312), a potential scan avoidance event is alerted, provided, stored, etc., a scan avoidance alarm signal is generated (block 314), and control returns to block 308 to determine whether the timeout period has expired. While not shown in FIG. 3 for clarity of illustration, when the another indicia is different from the first indicia and is decodable, it is conveyed to the POS system and, when the same indicia is detected, it not conveyed to the POS system.

Returning to block 312, if the another indicia is not the same as the first indicia (block 312), then a potential scan avoidance event is not alerted, provided, stored, etc., a scan avoidance alarm signal is not generated (block 316), and control returns to block 308 to determine whether the timeout period has expired (block 308).

Returning to block 310, if another indicia is not detected (block 310), then a potential scan avoidance event is not alerted, provided, stored, etc., and a scan avoidance alarm signal is not generated (block 316), and control returns to block 308 to determine whether the timeout period has expired (block 308).

Returning to block 308, if the timeout period has expired (block 308), control exits from the example program of FIG. 3.

FIG. 4 is a block diagram representative of an example logic circuit capable of implementing, for example, the barcode decoder 220, the scan avoidance event detector 222 and/or, more generally, the PCB 211. The logic circuit of FIG. 4 is a processing platform 400 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 400 of FIG. 4 includes an example processor 402 such as, for example, one or more microprocessors, controllers, and/or any suitable type of processor. The processing platform 400 of FIG. 4 includes memory (e.g., volatile memory, non-volatile memory) 404 accessible by the processor 402 (e.g., via a memory controller). The processor 402 interacts with the memory 404 to obtain, for example, machine-readable instructions stored in the memory 404 corresponding to, for example, the operations represented by the flowcharts and/or examples of this disclosure. Additionally or alternatively, machine-readable instructions corresponding to the example operations described herein may be stored on one or more removable media (e.g., a compact disc (CD), a digital versatile disk (DVD), removable flash memory, etc.) that may be coupled to the processing platform 400 to provide access to the machine-readable instructions stored thereon. The machine-readable instructions may be executed by the processor 402 to implement barcode decoder 220 and the scan avoidance event detector 222. The memory 404 may additionally store scan avoidance event alerts at the barcode reader 200, a remote server, etc.

The example processing platform 400 of FIG. 4 also includes a network interface 406 to enable communication with other machines via, for example, one or more networks. The network interface 406 includes any suitable type of communication interface(s) (e.g., wired and/or wireless interfaces) configured to operate in accordance with any suitable protocol(s). The network interface 406 may be used to communicatively couple the barcode reader 200 to a remote device.

The processing platform 400 of FIG. 4 also includes input/output (I/O) interfaces 408 to access image data from imaging devices, cameras, the imaging assemblies 212, 214, etc.

Although FIG. 4 depicts the I/O interfaces 408 as a single block, the I/O interfaces 408 may include a number of different types of I/O circuits or components that enable the processor 402 to communicate with peripheral I/O devices. Example interfaces 408 include an Ethernet interface, a universal serial bus (USB) interface, a Bluetooth® interface, a near field communication (NFC) interface, and/or a PCI Express interface. The peripheral I/O devices may be any desired type of I/O device such as a keyboard, a display (a liquid crystal display (LCD), a cathode ray tube (CRT) display, a light emitting diode (LED) display, an organic light emitting diode (OLED) display, an in-place switching (IPS) display, a touch screen, etc.), a navigation device (a mouse, a trackball, a capacitive touch pad, a joystick, etc.), a speaker, a microphone, a printer, a button, a communication interface, an antenna, etc.

The above description refers to a block diagram of the accompanying drawings. Alternative implementations of the example represented by the block diagram include one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more DSPs, one or more ASICs, one or more FPGAs, one or more MCUs, one or more hardware accelerators, one or more special-purpose computer chips, and one or more SoC devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Further still, unless expressly stated to the contrary, “or” refers to an inclusive or and not to an exclusive or. For example, “A, B or C” refers to any combination or subset of A, B, C such as (1) A alone, (2) B alone, (3) C alone, (4) A with B, (5) A with C, (6) B with C, and (7) A with B and with C. As used herein, the phrase “at least one of A and B” is intended to refer to any combination or subset of A and B such as (1) at least one A, (2) at least one B, and (3) at least one A and at least one B. Similarly, the phrase “at least one of A or B” is intended to refer to any combination or subset of A and B such as (1) at least one A, (2) at least one B, and (3) at least one A and at least one B.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A computer-implemented method for detecting a potential scan avoidance during a decode session using a symbology reader, the method comprising:
decoding, during a timeout period at one or more processors of the symbology scanner, a first indicia in a first image captured during the timeout period to determine a first indicia payload;
conveying, during the timeout period at the one or more processors, the first indicia payload to a point-of-sale (POS) system for affecting a transaction;
detecting, during the timeout period at the one or more processors, a second indicia in the first image or in a subsequent image captured during the timeout period; and
in response to determining that the second indicia is the same as the first indicia and is decodable, determining a potential scan avoidance attempt and generating a scan avoidance alarm signal.

2. The method of claim 1, further comprising, in response to determining that the second indicia is different from the first indicia and is decodable, determining a potential scan avoidance attempt has not occurred and not generating a scan avoidance alarm signal.

3. The method of claim 2, further comprising:
determining a second indicia payload for the second indicia; and
conveying the second indicia payload to the POS system.

4. The method of claim 1, further comprising, in response to determining that the second indicia is not decodable, not determining a potential scan avoidance attempt and not generating a scan avoidance alarm signal.

5. The method of claim 1, wherein the second indicia includes the first indicia captured an additional time.

6. The method of claim 1, further comprising starting the timeout period when the first indicia is detected.

7. The method of claim 1, wherein the symbology reader includes a bi-optic reader having a tower portion with a first field of view and a platter portion with a second field of view, and further comprising starting the timeout period when the first indicia is detected via at least one of the first field of view or the second field of view.

8. The method of claim 1, wherein the symbology reader is a bi-optic reader, having a tower portion with a first field of view and a platter portion with a second field of view.

9. The method of claim 1, wherein the symbology reader is a handheld reader.

10. The method of claim 1, wherein the symbology reader is a presentation mode reader.

11. The method of claim 1, wherein the first indicia includes a universal product code (UPC) or a European article number (EAN).

12. The method of claim 1, further comprising, in response to determining the potential scan avoidance attempt, identifying at least one of the first image or the subsequent image as a scan avoidance image.

13. The method of claim 12, wherein the scan avoidance image includes the first indicia.

14. The method of claim 1, further comprising sending the scan avoidance alarm signal to a remote device for presentation to an individual distinct from a user of the symbology reader.

15. The method of claim 1, further comprising presenting the scan avoidance alarm signal to a user of the symbology reader.

16. A system for detecting a scan avoidance event during a decode session, the system comprising:
an imaging assembly configured to capture, during a timeout period, a first image of a first indicia, and a second image;
a barcode decoder configured to, during the timeout period, decode the first indicia to determine a first indicia payload and convey the first indicia payload to a point-of-sale (POS) system; and
a scan avoidance event detector configured to, during the timeout period, in response to determining that a second indicia is the first image and is decodable, determine a potential scan avoidance attempt and generate a scan avoidance alarm signal.

17. The system of claim 16, further comprising:
a processor; and
a tangible machine-readable storage medium storing machine-readable instructions that, when executed by the processor, cause the processor to implement the scan avoidance event detector.

18. The system of claim 16, wherein the scan avoidance event detector is configured to, in response to determining that the second indicia is different from the first indicia and is decodable, determine a potential scan avoidance attempt has not occurred and not generating a scan avoidance alarm signal.

19. The system of claim 16, wherein the barcode decoder is configured to:
determine a second indicia payload for the second indicia; and
convey the second indicia payload to the POS system.

20. The system of claim 16, wherein the scan avoidance event detector is configured to, in response to determining that the second indicia is not decodable, not determine a potential scan avoidance attempt and not generate a scan avoidance alarm signal.

21. The system of claim 16, wherein the scan avoidance event detector is configured to, in response to determining the potential scan avoidance attempt, identify at least one of the first image or the subsequent image as a scan avoidance image.

22. The system of claim 16, wherein the scan avoidance image includes the first indicia.
The system of claim 16, wherein the scan avoidance event detector is configured to send the scan avoidance alarm signal to at least one of a remote device for presentation to an individual distinct from a user of the symbology reader, or a user of the symbology reader.
